(19) United States
(12) Patent Application Publication
(10) Pub. No.: US 2013/0321297 A1
(43) Pub. Date: Dec. 5, 2013

(54) UNLOCKING METHOD FOR AN ELECTRONIC DEVICE WITH A TOUCH SCREEN

(71) Applicant: Liang Li, Shenzhen (CN)

(72) Inventor: Liang Li, Shenzhen (CN)

(21) Appl. No.: 13/758,325

(22) Filed: Feb. 4, 2013

(30) Foreign Application Priority Data
May 29, 2012 (CN) 201210171704.6

(51) Int. Cl. G06F 3/041

(52) U.S. Cl. CPC G06F 3/041
USPC 345/173

(57) ABSTRACT

An unlocking method for an electronic device with a touch screen, comprises displaying a plurality of unlocking buttons and indicating the touching sequence for touching the buttons on the touch screen when the touch screen is in a locked state in which the user interface is locked; detecting contact with the touch screen and determining whether the plurality of unlocking buttons are touched according to the indicated touching sequence; switching the user interface into an unlocked state if the plurality of buttons is touched according to the indicated touching sequence; and keeping the user interface in the locked state if the plurality of buttons are not touched according to the indicated touching sequence. The method is simple and convenient and can prevent unlocking through incorrect operation.

### PRIORITY

This application claims the benefit of priority of Chinese Patent Application 201210171704.6 filed May 29, 2012, the content of which is incorporated herein by reference.

### TECHNICAL FIELD

The present disclosure relates to the field of touch screens, in particular to an unlocking method for an electronic device with a touch screen.

### BACKGROUND

Touch screens, used more and more widely, can be found in mobile devices such as cell phone, music players, and tablet PCs. They are used as interfaces for user input. Mobile devices are often received in places that can be easily accessed, such as pockets and handbags, and thus have some functions triggered due to pressure on the touch screen applied by users. Accordingly, current mobile devices all have features of touch screen unlocking to prevent incorrect operation. There are various unlocking methods for unlocking touch screens, such as sliding unlocking or contacting two floating buttons. Sliding unlocking, however, may not be properly accomplished due to discontinuousness of the sliding caused by dirt on the screen or the hand or by trembling of the hand; and it is very inconvenient for a user to use floating buttons.

To address the aforementioned problem, a new unlocking method has been provided, which provides a plurality of unlocking buttons to be touched for unlocking Nevertheless the plurality of unlocking buttons will be touched simultaneously when the touch screen is pressurized by something, which unlocks the touch screen, resulting in incorrect operation.

### SUMMARY

To solve the problem identified above, it is necessary to provide an unlocking method for a touch screen that is convenient to operate and prevents incorrect operation.

The present disclosure provides an unlocking method for an electronic device with a touch screen, comprising: displaying a plurality of unlocking buttons and indicating the touching sequence for touching the unlocking buttons on the touch screen when the touch screen is in a locked state in which the user interface is locked; detecting contact with the touch screen and determining whether the plurality of unlocking buttons are touched according to indicated touching sequence; switching the user interface into an unlocked state if the plurality of buttons is touched according to the indicated touching sequence; and keeping the user interface in the locked state if the plurality of buttons are not touched according to the indicated touching sequence.

Compared with prior art, the unlocking method for an electronic device with a touch screen according to the present disclosure unlocks a touch screen by touching of unlocking buttons according to indicated sequence, which is simple and convenient and can prevent unlocking through incorrect operation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention

FIG. 1 is a flow chart of an unlocking method for an electronic device with a touch screen according to the present disclosure;

FIG. 2 is a view of a locked touch screen according to embodiment 1 of the present disclosure;

FIG. 3 is a view of a locked touch screen according to embodiment 2 of the present disclosure;

FIG. 4 is a view of a locked touch screen according to embodiment 3 of the present disclosure;

FIG. 5 is a view of a locked touch screen according to embodiment 4 of the present disclosure;

FIG. 6 is a view of a locked touch screen according to embodiment 5 of the present disclosure;

FIG. 7 is a view of a locked touch screen according to embodiment 6 of the present disclosure;

### DETAILED DESCRIPTION

References will now be made in detail to the present exemplary embodiments, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

As shown in FIG. 1, an unlocking method for a touch screen of an electronic device comprises:

In step 101, displaying a plurality of unlocking buttons and indicating a touching sequence for touching the buttons on the touch screen when the touch screen is in a locked state in which the user interface is locked;

In step 102, detecting contact with the touch screen and determining whether the plurality of unlocking buttons are touched according to the indicated touching sequence;

In step 103, switching the user interface into an unlocked state if the plurality of buttons is touched in a preset time period according to the indicated touching sequence; and

In step 104, keeping the user interface in the locked state if the plurality of buttons are not touched in a preset time period according to the indicated touching sequence.

In one alternative, among the plurality of available unlocking buttons, the unlocking button to be touched next to the unlocking button that has been touched is the untouched one that is closest to the unlocking button that has been touched. According to this touching rule, the moving distance for touching during unlocking by a user is the shortest, which renders the unlocking more convenient.

The above unlocking method is explained hereinafter with references to particular embodiments.

### Embodiment 1

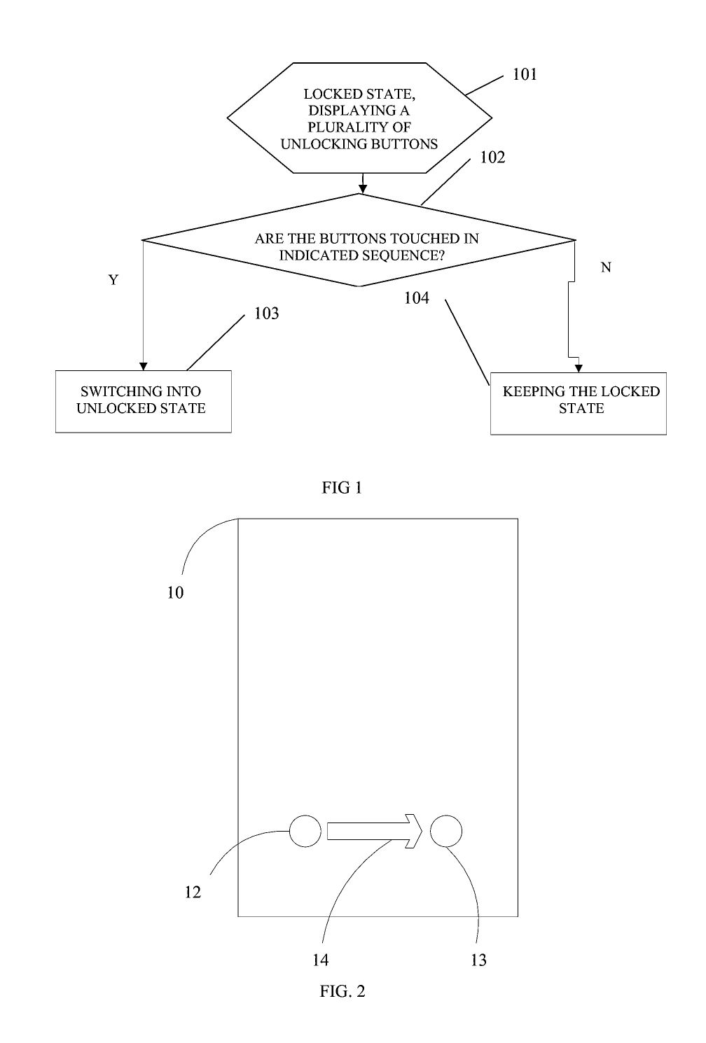

As shown in FIG. 2, when the touch screen 10 is in a locked state in which the user interface is locked, an unlocking button 12 and an unlocking button 13 are displayed on the screen 10, and the touching sequence for the unlocking button 12 and the unlocking button 13 is indicated with an arrow 14.

Then the contact with the touch screen 10 is detected and it is determined whether the unlocking buttons 12, 13 are touched according to the indicated touching sequence in a preset time period of 1 second. If the unlocking buttons 12, 13 are touched according to the indicated touching sequence in 1 second, the user interface of the touch screen 10 will be switched into an unlocked state. If the unlocking buttons 12, 13 are not touched according to the indicated touching sequence in 1 second, the user interface of the touch screen 10 will be kept in the locked state.

The time period of 1 second may be set according to practical needs, the value of 1 second is merely a sample for reference. After being touched, the color of the unlocking button 13 may turn darker, or the pattern of the unlocking button 13 may be changed more or less, so that the button is distinguishable from its state before being touched for easier recognition. During touching of the unlocking buttons, it may be determined that an incorrect operation takes place if the void between two unlocking buttons are touched; and thus the previous touching of an unlocking button is determined as ineffective, or the touching of the void may be ignored and the previous touching of an unlocking button is determined as effective. The touching of buttons that are not supposed to be touched, or the touching of the space between those buttons, can be dealt with similarly as the touching of the void between two unlocking buttons. There may actually be more than one arrow 14. A plurality of arrows can be used to indicate the touching sequence for unlocking. The line of an arrow does not have to be located between unlocking buttons, it can be located on the unlocking buttons. And the line of an arrow may be displayed statically or dynamically. The unlocking buttons are displayed herein in the shape of circles. The unlocking button shapes, however, may be squares, triangles, or any other suitable ones.

### Embodiment 2

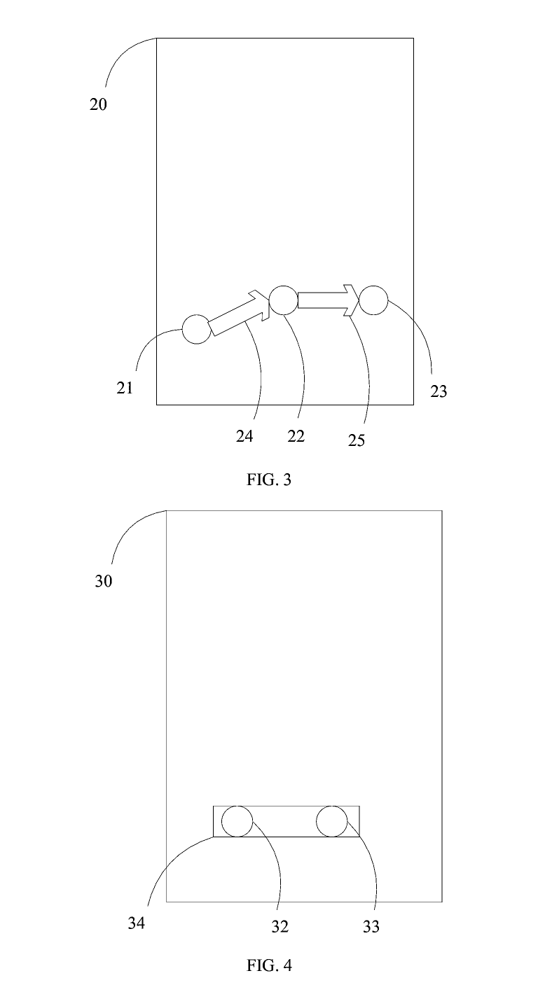

As shown in FIG. 3, when the touch screen 20 is in a locked state in which the user interface is locked, unlocking buttons 21, 22, and 23 are displayed on the screen 20, and the touching sequence for the unlocking buttons 21, 22, and 23 are indicated with arrows 24, 25.

Then the contact with the touch screen 20 is detected and it is determined whether unlocking buttons 21, 22, 23 are touched according to the indicated touching sequence in a preset time period of 0.5 second. If the unlocking buttons 21, 22, 23 are touched according to the indicated touching sequence in 0.5 second, the user interface of the touch screen 20 will be switched into an unlocked state. If the unlocking buttons 21, 22, 23 are not touched according to the indicated touching sequence in 0.5 second, the user interface of the touch screen 20 will be kept in the locked state.

Besides those as shown in the figure, the line of an arrow may also be located on the unlocking buttons 21, 22, 23. Even the unlocking buttons themselves may be arrow-shaped.

An error-correction process may be implemented. If the unlocking button 23 is touched right after the touching of the unlocking button 21, the operation is deemed to be an incorrect one, and the touching of the unlocking buttons is ineffective and it requires to touch the buttons again for unlocking. A time period, such as 0.5 second in the present embodiment, is set, within which the touching of the first unlocking button through the last one should be completed. Actually, conditions other than the condition of completing the touching within the time period may also be imposed. For example, the timing may be started from the time when a user's finger leaves the unlocking button after touching it and the time is halted when the finger is touching another unlocking button (i.e., only the time the user's finger is not touching on any unlocking button is timed, or only the time from the point a finger leaves one unlocking button and to the point the finger reaches another unlocking button is timed); if the timing exceeds a certain value, the operation will be treated as an incorrect one. If after leaving an unlocking button the finger touches the same unlocking button again instead of touching another unlocking button, the timing may be halted at the time the finger touches the unlocking button at the first time. Three unlocking buttons are shown in the embodiment; nevertheless one or two unlocking buttons may be added between every two unlocking buttons. In this way the unlocking buttons are arranged rather densely, and thus a finger may touch two buttons simultaneously when trying to touch one of them; in this case, the one that was touched first or the one that was touched later is taken as the button being touched, or it may be deemed that no unlocking button has been touched.

In addition, the 3 unlocking buttons shown in FIG. 3 are not aligned in one line. It is obvious that the angle formed by the lines connecting the 3 buttons is in the range greater than or equal to 90 degree and smaller than or equal to 180 (or described in another way, greater than or equal to 180 degree and smaller than or equal to 270), which makes it more convenient to touch the buttons. Provided that it is convenient to arrange the buttons and for a user to touch them, there is no limit on the number of the unlocking buttons, although 2-6 of them are preferable.

### Embodiment 3

As shown in FIG. 4, when the touch screen 30 is in a locked state in which the user interface is locked, an unlocking button 32 and an unlocking button 33 are displayed on the screen 30, and the touching sequence for the unlocking buttons 32, 33 is indicated with a track 34.

Then the contact with the touch screen 30 is detected and it is determined whether unlocking buttons 32, 33 are touched according to the indicated touching sequence in a preset time period of 2 seconds. If the unlocking buttons 32, 33 are touched according to the indicated touching sequence in 2 seconds, the user interface of the touch screen 30 will be switched into the unlocked state. If the unlocking buttons 32, 33 are not touched according to the indicated touching sequence in 2 seconds, the user interface of the touch screen 30 will be kept in the locked state.

The track 34 of the embodiment indicates the touching sequence for unlocking. Besides, the touching sequence can be indicated dynamically by varying the brightness of the unlocking buttons or by flashing the buttons alternatively or simultaneously. Furthermore, the touching sequence can be indicated by displaying characters or phrases, such as “locking” or “unlocking” or a picture of a lock in a locked or unlocked condition, or any other suitable ones (including pictures or icons imprinted with Chinese characters “ [symbol] ” or “ [symbol] ”) on the unlocking buttons.

### Embodiment 4

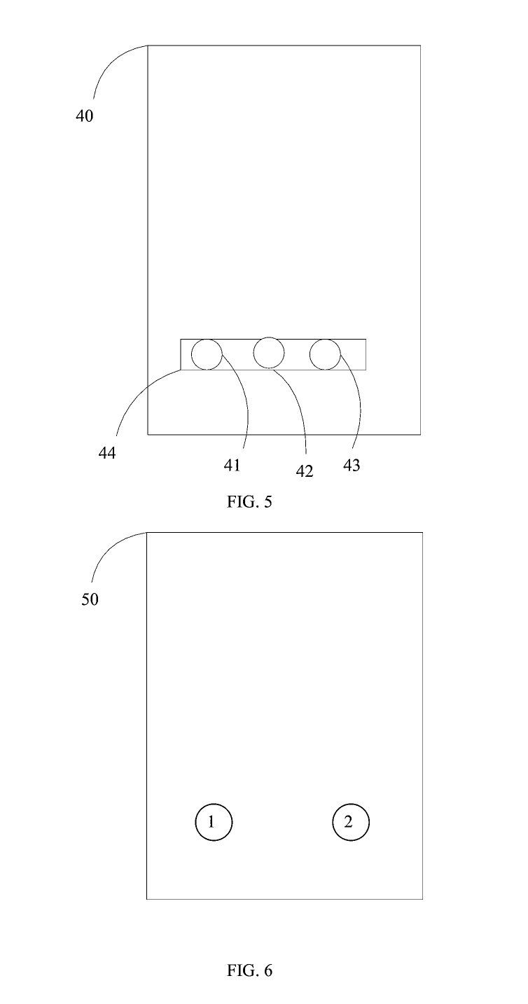

As shown in FIG. 5, when the touch screen 40 is in a locked state in which the user interface is locked, unlocking buttons 41, 42, and 43 are displayed on the screen 40, and the touching sequence for the unlocking buttons 41, 42, and 43 is indicated with a track 44.

Then the contact with the touch screen 40 is detected and it is determined whether the unlocking buttons 41, 42, 43 are touched according to the indicated touching sequence in a preset time period of 1 second. If the unlocking buttons 41, 42, 43 are touched according to the indicated touching sequence in 1 second, the user interface of the touch screen 40 will be switched into an unlocked state. If the unlocking buttons 41, 42, 43 are not touched according to the indicated touching sequence in 1 second, the user interface of the touch screen 40 will be kept in the locked state.

As shown in FIG. 5, the 3 unlocking buttons are aligned in one line; buttons in a line are relatively more convenient for touching. Also, the electronic device can even be unlocked through sliding-touching of the 3 unlocking buttons according to the indicated touching sequence for unlocking, in which case the touching device (a user's finger, touching rod, or any other suitable device) need not move away from the touch screen. While 3 unlocking buttons are shown in FIG. 5, the method can use more buttons.

### Embodiment 5

As shown in FIG. 6, when the touch screen 50 is in a locked state in which the user interface is locked, an unlocking button 1 and an unlocking button 2 are displayed on the screen 50, and the touching sequence for unlocking is indicated by displaying characters “1” and “2” on the buttons 1 and 2 respectively.

Then the contact with the touch screen 50 is detected and it is determined whether the unlocking buttons 1, 2 are touched according to the indicated touching sequence in a preset time period of 1 second. If the unlocking buttons 1, 2 are touched according to the indicated touching sequence in 1 second, the user interface of the touch screen 50 will be switched into an unlocked state. If the unlocking buttons 32, 33 are not touched according to the indicated touching sequence in 1 second, the user interface of the touch screen 50 will be kept in the locked state.

The numbers displayed on the unlocking buttons 1, 2 of the embodiment can be replaced with other numbers, and more numbers may be added if more buttons are displayed; and the numbers may be substituted with other characters, such as “unlocking” and “locking” or any other suitable ones (including pictures or icons imprinted with Chinese characters “ [symbol] ” and “ [symbol] ”).

### Embodiment 6

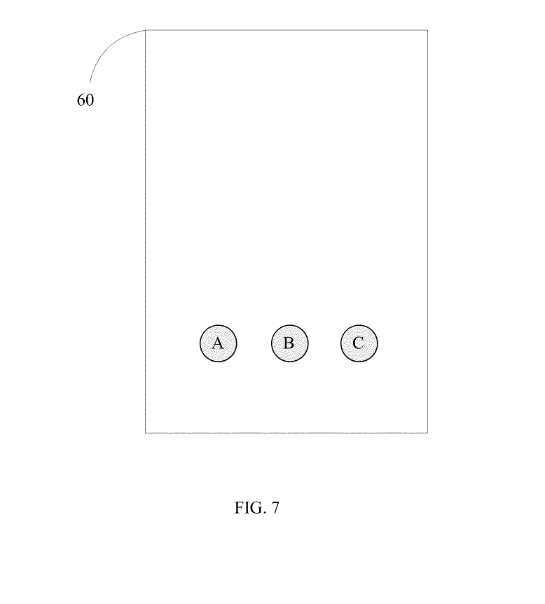

As shown in FIG. 7, when the touch screen 60 is in a locked state in which the user interface is locked, an unlocking button A, an unlocking button B, and an unlocking button C are displayed on the screen 60, and the touching sequence for unlocking is indicated by displaying characters “A”, “B”, and “C” on the buttons “A”, “B”, and “C” respectively.

Then the contact with the touch screen 60 is detected and it is determined whether the unlocking button A, unlocking button B, and unlocking button C are touched according to the indicated touching sequence in a preset time period of 1 second. If they are touched according to the indicated touching sequence in 1 second, the user interface of the touch screen 60 will be switched into the unlocked state. If they are not touched according to the indicated touching sequence in 1 second, the user interface of the touch screen 40 will be kept in the locked state.

The letters employed in the embodiment can be replaced with other letters or characters, and more buttons can be used. For example, if 4 buttons are displayed, “OPEN”, or “unlocking button” or “touching button” or “unlocking” or “sliding unlocking” or any other suitable words, phrases, pictures, or icons (including those imprinted with Chinese characters “ [symbol] ”, “ [symbol] ”, and “ [symbol] ”) can be displayed on the 4 buttons, or they may be substituted with other characters, such as “unlocking” and “locking.” Additional approaches, such as variation in brightness and pattern indication, can also be used.

The aforementioned embodiments of the unlocking method can be implemented by a CPU or an on-board chip of an electronic device with a touch screen. The CPU or the on-board chip can comprise at least circuitry, memory, programming, and processor for storing algorithms and data for carrying out the steps as described above. The CPU or the on-board chip can communicate with the displayer of the electronic device to display the unlocking buttons as well as other information. The CPU or the on-board chip can also communicate with the touch screen of the electronic device to detect contact with the touch screen. The circuitry, memory and processor of the CPU or the on-board chip can be shared with other devices of the electronic device or exclusive to steps of the unlocking method as described above. Exclusivity would require additional hardware, while sharing would require appropriate allocation programming. In either case, stored data and algorithms can be fed to the processor for computational processing to implement steps of the unlocking method. The method may also be embodied in downloadable or installable form, such as in a tangible computer readable media. The computer readable media may comprise at least a memory and programming stored in the memory. The memory may be any one of a RAM, ROM, disk, drive, or other tangible storage device for computer programming. The computer readable media must be readable by a processor of a computing device, such as a processor of a hand held device, so that the instructions contained thereon may be executed by the device.

Compared with prior art, the unlocking method according to the present disclosure unlocks a touch screen with a way of touching unlocking buttons according to an indicated sequence. The method is simple and convenient and can prevent unlocking through incorrect operation.

In the preceding specification, various preferred embodiments have been described with reference to the accompanying drawings. It will, however, be evident that various other modifications and changes may be made thereto, and additional embodiments may also be implemented, without departing from the broader scope of the invention as set forth in the claims that follow. For example, the touching sequence can be indicated by variation of the brightness of the unlocking buttons; the number of the unlocking buttons can be 2-6; the unlocking buttons can be aligned in a line or can be arranged zigzaggedly; when there are 3 or more unlocking buttons, any angle formed by any three adjacent unlocking buttons are greater than or equal to 90 degree and less than or equal to 180 degree; the connecting lines of the unlocking buttons according to the touching sequence do not cross one another.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

We claim:

1. An unlocking method for an electronic device with a touch screen, comprising:
displaying a plurality of unlocking buttons and indicating a touching sequence for touching the unlocking buttons on the touch screen when the touch screen is in a locked state in which the user interface is locked;
detecting contact with the touch screen and determining whether the plurality of unlocking buttons are touched according to the indicated touching sequence;
switching the user interface into an unlocked state if the plurality of buttons are touched according to the indicated touching sequence; and
keeping the user interface in the locked state if the plurality of buttons are not touched according to the indicated touching sequence.

2. The unlocking method according to claim 1, wherein the user interface is switched into an unlocked state if the plurality of buttons are touched according to the indicated touching sequence and are touched in a preset time period, and the user interface is kept in the locked state if the plurality of buttons are not touched according to the indicated touching sequence or are not touched in the preset time period.

3. The unlocking method according to claim 1, wherein there are 2 to 6 of the unlocking buttons.

4. The unlocking method according to claim 1, wherein the plurality of unlocking buttons comprises a first unlocking button and a second unlocking button, and when indicating the touching sequence among the plurality of unlocking buttons, the first unlocking button is indicated and then the second unlocking button is indicated in the sequence, and the second unlocking button is the closest of the plurality of unlocking buttons to the first unlocking button.

5. The unlocking method according to claim 4, wherein indicating the touching sequence further comprises displaying connecting lines between unlocking buttons, and wherein the connecting lines do not cross one another.

6. The unlocking method according to claim 4, wherein the plurality of unlocking buttons are aligned in one line.

7. The unlocking method according to claim 4, wherein there are 3 or more adjacent unlocking buttons, and an angle formed by three adjacent unlocking buttons is greater than or equal to 90 degrees and less than or equal to 180 degrees.

8. The unlocking method according to claim 4, wherein there are 3 or more adjacent unlocking buttons, and an angle formed by three adjacent unlocking buttons is greater than or equal to 180 degrees and less than or equal to 270 degrees.

9. The unlocking method according to claim 1, wherein the touching sequence is indicated with a variation of brightness of the unlocking buttons.

10. The unlocking method according to claim 1, wherein when the electronic device is in a locked state in which the user interface is locked, the touching sequence of the plurality of unlocking buttons is indicated with arrows while the plurality of unlocking buttons are displayed on the screen.

11. The unlocking method according to claim 1, wherein when the electronic device is in a locked state in which the user interface is locked, the touching sequence of the plurality of unlocking buttons is indicated by a track while the plurality of unlocking buttons are displayed on the screen.

12. The unlocking method according to claim 1, wherein when the electronic device is in a locked state in which the user interface is locked, the touching sequence of the plurality of unlocking buttons is indicated with characters displayed on the buttons while the plurality of unlocking buttons are displayed on the screen.

13. The unlocking method according to claim 1, wherein the plurality of unlocking buttons comprises a first unlocking button and a second unlocking button, and when indicating the touching sequence among the plurality of unlocking buttons, the first unlocking button is indicated and then the second unlocking button is indicated in the sequence, and a touching of the first unlocking button is determined ineffective if the second button is not touched within a preset time period after the touching of the first unlocking button.

14. The unlocking method according to claim 1, wherein the preset time period is one of 0.5 second, 1 second, and 2 seconds.

15. A tangible computer readable media comprising at least a memory and programming for an unlocking method for an electronic device with a touch screen, the programming comprising instruction for:
displaying a plurality of unlocking buttons and indicating a touching sequence for touching the unlocking buttons on the touch screen when the touch screen is in a locked state in which the user interface is locked;
detecting contact with the touch screen and determining whether the plurality of unlocking buttons are touched according to the indicated touching sequence;
switching the user interface into an unlocked state if the plurality of buttons are touched according to the indicated touching sequence; and
keeping the user interface in the locked state if the plurality of buttons are not touched according to the indicated touching sequence.
